(19) United States
(12) Patent Application Publication
(10) Pub. No.: US 2019/0360205 A1
(43) Pub. Date: Nov. 28, 2019

(54) NON-MOISTURE ABSORBING FACERS FOR INSULATION PRODUCTS

(71) Applicant: JOHNS MANVILLE, Denver, CO (US)

(72) Inventors: Jayamalar Dorsey, Broomfield, CO (US); Lance Bonin, Aurora, CO (US)

(21) Appl. No.: 15/987,342

(22) Filed: May 23, 2018

(51) Int. Cl. E04C 2/296; B32B 5/02; B32B 15/04; B32B 27/36; B32B 27/32; B32B 7/12; B32B 29/00; B32B 37/18; E04B 9/04

(52) U.S. Cl. CPC E04C 2/296; B32B 2307/402; B32B 15/04; B32B 27/36; B32B 27/32; B32B 7/12; B32B 29/002; B32B 37/182; E04B 9/045; B32B 2323/10; B32B 2419/04; B32B 2307/304; B32B 2255/10; B32B 2255/205; B32B 5/024

(57) ABSTRACT

The embodiments described herein are related to facers for insulation products, and more specifically relate to non-moisture absorbing facers for fiberglass based construction boards. The insulation products described herein may include a base insulation layer composed of or including a composite or construction board, blanket, batt, pipes, or roll. Fiberglass based construction or composite boards are often used to insulate residential, industrial, or commercial structures (e.g., metal glass buildings) or components (e.g., HVAC equipment, ductwork, piping). An insulation product as provided includes a base insulation layer (e.g., a construction or composite board) and at least one non-moisture absorbing facer bonded, laminated, or otherwise suitably coupled (e.g., with adhesive) to one or more sides or surfaces of the base insulation layer. The non-moisture absorbing facer is constructed without moisture absorbing layers such as kraft or tissue paper layers.

### BACKGROUND

The present disclosure relates generally to facers for insulation products, and more specifically relates to non-moisture absorbing facers for fiberglass based construction boards. Fiberglass based construction or composite boards often include entangled glass fibers that are adhered together with a binder, such as a thermosetting binder. Generally, the fiberglass based construction or composite boards also include a facer or facing positioned on one or more sides of the construction or composite board for aesthetic or other purposes, such as providing a vapor barrier to control condensation, providing a protective barrier, increasing fire performance, improving energy efficiency, and the like. In some instances, the facer or facing may be used to protect or hold the fiberglass insulation layer of the construction or composite board together. Examples of facers commonly used with fiberglass based construction or composite boards include foil-scrim-kraft (FSK) or all service jacket (ASJ). Such facers include a laminated kraft paper layer. As the kraft paper layer may absorb moisture in certain environments, climates, or structures, undesirable wrinkling or welting may occur in the facer. Therefore, there remains a need for improved facers for insulation products including fiberglass based construction boards that are less susceptible to, reduce, or prevent undesirable wrinkling or welting when exposed to humidity or other moisture.

### BRIEF SUMMARY

The embodiments described herein relate generally to facers for insulation products, and more specifically relate to non-moisture absorbing facers for fiberglass based construction boards. The insulation products may include a base insulation layer constructed or composed of a composite or construction board, blanket, batt, pipe, or roll. The construction board typically includes at least a fiberglass based board layer made of an inorganic material (e.g., glass fibers) and a non-moisture absorbing facer on one or more sides or surfaces of the board. The non-moisture absorbing facer exhibits exceptional resistance to or reduced wrinkling or welting when exposed to humidity or other moisture relative to commonly available facers that include moisture absorbing layer such as kraft paper. The non-moisture absorbing facer is typically composed of or includes one or more layers. For example, the non-moisture absorbing facer may include first and second film layers and a reinforcing layer sandwiched therebetween, and bonded together with adhesive, although other compositions and methods of binding or coupling the layers (e.g., with fasteners) are also possible. Such non-moisture absorbing facers do not include or specifically exclude moisture absorbing layers (e.g., kraft or tissue paper) on top, on bottom, between, or forming a portion of the other layers of the non-moisture absorbing facer. For example, the non-moisture absorbing facers are constructed without kraft or tissue paper layers.

According to a first aspect, a non-moisture absorbing facer for an insulation product having improved resistance to wrinkling or welting due to moisture is provided. The non-moisture absorbing facer includes one or more layers configured to be coupled to an insulation layer to form an insulation product. The one or more layers include a reinforcing layer and exclude a moisture absorbing layer between the one or more layers. In some embodiments, the moisture absorbing layer that is excluded is a kraft paper layer.

In some embodiments, the one or more layers include a first film layer and a second film layer. The first and second film layers sandwich the reinforcing layer therebetween. The first film layer and the second film layer may include a polymeric film. The first film layer may include a polypropylene film or coated polyester film. The polypropylene film may include a substantially white-colored film. In some embodiments, the second film layer includes a metallized polyester film or metallized foil.

In certain embodiments, the reinforcing layer includes a fiberglass mat. The fiberglass mat may be constructed from a tri-directional fiberglass scrim. In some embodiments, the one or more layers of the non-moisture absorbing facer are laminated together.

In some embodiments, the one or more layers consist of a first film layer and a second film layer sandwiching the reinforcing layer therebetween, the layers being bonded together with an adhesive. In some embodiments, the non-moisture absorbing facer includes an insulation layer coupled to the non-moisture absorbing facer. The insulation layer may be constructed from a fiberglass based construction board.

In some embodiments, the first film layer of the non-moisture absorbing facer is bonded directly to the reinforcing layer with an adhesive without any intermediary layers. In some embodiments, the bottom surface of the second film layer is laminated directly to a top surface of the insulation layer with an adhesive without any intermediary layers. The non-moisture absorbing facer and the fiberglass based construction board may form a ceiling tile in certain embodiments.

According to a second aspect, an insulation product having improved resistance to wrinkling or welting due to moisture is provided. The insulation product includes a base insulation layer and a non-moisture absorbing facer bonded to the base insulation layer. The non-moisture absorbing facer includes one or more layers. The one or more layers include a reinforcing layer while the one or more layers exclude a moisture absorbing layer between the one or more layers.

In some embodiments, the one or more layers include a first film layer and a second film layer. The first and second film layers sandwich the reinforcing layer therebetween. The base insulation layer may include a fiberglass based construction board. In certain embodiments, the non-moisture absorbing facer is pre-fabricated without the kraft paper layer prior to being bonded to the base insulation layer. The non-moisture absorbing facer may have a thickness in a range between 0.005 and 0.009 inches. The insulation product may be configured to be used as a ceiling tile.

According to a third aspect, a method of manufacturing a non-moisture absorbing facer for an insulation product is provided that includes bonding a first film layer directly to a first side of a fiberglass reinforcing layer without a moisture absorbing intermediary layer therebetween; and bonding a second film layer directly to a second opposing side of the fiberglass reinforcing layer without a moisture absorbing intermediary layer therebetween.

In some embodiments, the first film layer includes a polypropylene layer. The second film layer may include a metallized polyester layer. The fiberglass reinforcing layer may include a tri-directional fiberglass scrim.

In some embodiments, the method of manufacturing a non-moisture absorbing facer further includes laminating the non-moisture absorbing facer to a construction board. The non-moisture absorbing facer may be laminated with between 3 g/ft² and 7 g/ft² weight adhesive to the construction board. In certain embodiments, the second film layer is laminated directly to a surface of the construction board without an intermediary layer. The non-moisture absorbing facer and construction board may form a ceiling tile. In some embodiments, the non-moisture absorbing facer has a thickness in a range between 0.005 and 0.009 inches.

According to a fourth aspect, an insulation product is provided that consists essentially of a base insulation layer and a non-moisture absorbing facer bonded to the base insulation layer. The non-moisture absorbing facer does not include a kraft paper layer. In some embodiments, the non-moisture absorbing facer does not include a tissue paper layer as well as a kraft paper layer. In some embodiments, the base insulation layer is a fiberglass based construction board. In some embodiments, the insulation product may include adhesive to bond or laminate the non-moisture absorbing facer to the base insulation layer.

According to a fifth aspect, a kraft free facer for an insulation product is provided that includes one or more layers configured to be coupled to an insulation layer to form an insulation product. The one or more layers including a reinforcing layer and the one or more layers exclude a kraft paper layer between the one or more layers.

### BRIEF DESCRIPTION OF THE DRAWINGS

FIG. 1A is a sectional view of an insulation product with a base insulation layer and non-moisture absorbing facer in accordance with an exemplary embodiment of the present disclosure. FIGS. 1B and 1C are perspective views of the non-moisture absorbing facer and base insulation layers, respectively, of the insulation product of FIG. 1A.

### DETAILED DESCRIPTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

“ASTM” refers to American Society for Testing and Materials and is used to identify a test method by number. The year of the test method is either identified by suffix following the test number or is the most recent test method prior to the priority date of this document.

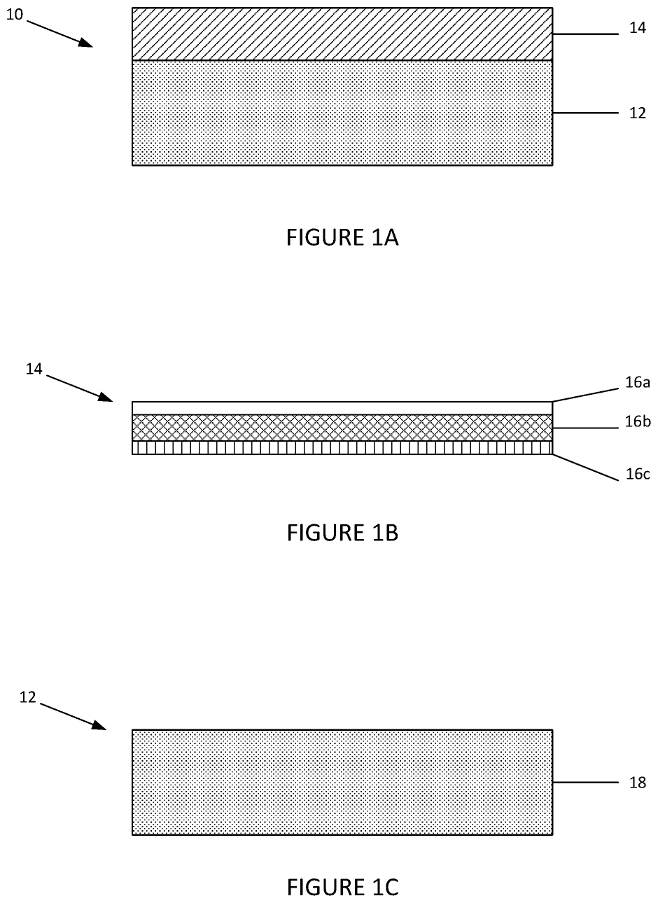

The embodiments described herein are related to facers for insulation products, and more specifically relate to non-moisture absorbing facers for fiberglass based construction boards. As described herein, the non-moisture absorbing facers do not include or specifically exclude moisture absorbing layers (e.g., kraft or tissue paper) on top, on bottom, between, or forming a portion of the other layers of the non-moisture absorbing facer. More specifically, in some embodiments, the non-moisture absorbing facers described herein exclude any layer that may readily absorb moisture. For example, the non-moisture absorbing facers may be kraft-free facers or exclude kraft paper layers. The terms “kraft” or “kraft paper” as used herein refer to paper or paperboard (e.g., cardboard) produced from chemical pulp produced in a kraft process that are, for example, used in commonly available FSK and ASJ facers. Excluding or not including layers that readily absorb moisture (e.g., kraft or tissue paper) in construction of such facers may help prevent or reduce wrinkling and welting of the facers or resulting insulation products (e.g., when exposed to humidity or other high moisture environments). In addition to or instead of reducing or preventing wrinkling or welting, constructing facers without moisture absorbing layers as described herein may also improve permeation, corrosion, or prevent or reduce fungi or bacterial growth in the facers or resulting insulation products. The insulation products described herein may include a base insulation layer composed of or including a composite or construction board, blanket, batt, pipes, or roll. Fiberglass based construction or composite boards are often used to insulate residential, industrial, or commercial structures (e.g., metal glass buildings) or components (e.g., HVAC equipment, ductwork, piping). With reference to FIGS. 1A-1C, an insulation product 10 as described herein includes a base insulation layer 12 (e.g., a construction or composite board or other suitable insulation layer) and at least one non-moisture absorbing facer 14 bonded, laminated, or otherwise suitably coupled (e.g., with adhesive) to one or more sides or surfaces of the base insulation layer 12. In some embodiments, the base insulation layer 12 may include a non-moisture absorbing facer as described herein on opposing sides or surfaces.

As illustrated in FIG. 1B, the non-moisture absorbing facer 14 comprises one or more layers 16 laminated, coated, or otherwise bonded together. The non-moisture absorbing facer 14 may comprise, for example, a first film layer 16a, a reinforcing layer 16b, and a second film layer 16c, bonded or laminated together with adhesive, although other compositions (e.g., with additional, different, intermediary or one or more omitted layers) and methods of binding or coupling the layers (e.g., with fasteners) are also possible. In some embodiments, layers are omitted (e.g., the first film layer or the second film layer). The first film layer 16a and the second film layer 16c may be laminated, bonded to, or coated over opposing sides or surfaces of the reinforcing layer 16b to sandwich the reinforcing layer 16b therebetween. The non-moisture absorbing facer 14 excludes (e.g., does not include) any moisture absorbing layer(s) (e.g., kraft or tissue paper) or core. For example, in some embodiments, the non-moisture absorbing facer 14 does not include kraft paper between the first film layer 16a and the reinforcing layer 16b or kraft paper does not form a portion of the first film layer 16a or the reinforcing layer 16b. Excluding or constructing the non-moisture absorbing facer 14 without a moisture absorbing layer (e.g., kraft paper) may allow or enable the non-moisture absorbing facer 14 to exhibit exceptional resistance to wrinkling or welting when exposed to humidity or other moisture relative to a facer that includes a kraft paper layer or other moisture absorbing layer as described in more detail below. Further, in some embodiments, constructing facers without moisture absorbing layers as described herein may also improve permeation, corrosion, or prevent or reduce fungi or bacterial growth in the facers or resulting insulation products, in addition to or instead of, reducing or preventing wrinkling. In other embodiments, the non-moisture absorbing facer 14 does not include a tissue paper layer, in addition to not including a kraft paper layer as described in more detail below.

The first film layer 16a may be a polymeric layer (e.g., polypropylene film, coated polyester, or other suitable material). In some embodiments, the first film layer 16a may be a polypropylene film. For example, the first film layer 16a may be a white or substantially white film layer made of polypropylene. As the first film layer 16a may be a top surface or layer exposed in use (e.g., in a residential or commercial building), providing a white film layer or other suitably colored film may improve aesthetics as the non-moisture absorbing facer 14 may be less noticeable or blend in with an interior of a residential or commercial building. The first film layer 16a may also have a coating or be made of a suitable material such that it can be easily wiped of dust or other dirt particles. In other embodiments, the first film layer 16a may have an additional or different property, such as a desired smoothness, texture, and the like. The first film layer 16a may be adhered to a first side or surface (e.g., top side) of reinforcing layer 16b. For example, the first film layer 16a may be adhered with a flame resistant or retardant adhesive to the reinforcing layer 16b. The reinforcing layer 16b may be a fiberglass mat (e.g., a tri-directional reinforcing fiberglass scrim, yarn, or cloth). The second film layer 16c may be a polymeric film (e.g., a metallized polyester) or foil (e.g., an aluminum) layer adhered (e.g., bonded, coated, or otherwise laminated) to a second side or surface (e.g., bottom side) of the reinforcing layer 16b with an adhesive. For example, the flame resistant or retardant adhesive may be applied to the reinforcing layer 16b to couple the first and second films 16a and 16c to opposing sides of the reinforcing layer 16b.

According to exemplary embodiments, common values for a thickness of the first film layer 16a (e.g., polypropylene film layer) of the non-moisture absorbing facer 14 include between 0.0005 and 0.0025 inches, or between 0.0010 and 0.0020 inches, or 0.0015 inches. As described above, reinforcing layer 16b may be a tri-directional reinforcing fiberglass scrim. The fiberglass scrim may have fiberglass strands of 4 per inch in machine and cross machine directions (e.g., MD and XMD), or 5 per inch in MD and XMD, or 6 per inch in MD and XMD. Common values for a thickness of the second film layer 16c (e.g., metallized polyester film layer) include between about 0.0003 and 0.0007 inches, or between about 0.0004 and 0.0006 inches, or 0.0005 inches.

According to exemplary embodiments, common values of a weight of the non-moisture absorbing facer 14 include between 8 and 28 lbs/1000 ft², or between 10 and 20 lbs/1000 ft², or between 12 and 16 lbs/1000 ft², or 14 lbs/1000 ft². According to ASTM C1136, common values of tensile strength of the non-moisture absorbing face 14 include between 25 and 55 lbs/inch width in MD and XMD, or between 30 and 50 lbs/inch width in MD and XMD, or between 35 and 45 lbs/inch width in MD and XMD, or 35 lbs/inch width in MD and XMD. Common values of bursting strength of the non-moisture absorbing facer 14 according to ASTM D774 include between 80 and 100 psi, or 100 psi. Common values of permeance according to ASTM E96 of the non-moisture absorbing facer 14 include between 0.01 and 0.03 perm, or 0.02 perm. Common values for a thickness of the non-moisture absorbing facer 14 include between 0.005 to 0.009 inches, or between 0.0055 and 0.0075 inches, or 0.007 inches. Light reflectance according to ASTM C523 of non-moisture absorbing facer 14 includes between 70 and 90%, or between 75 and 85%, or 85%.

As illustrated in FIG. 1C, the base insulation layer 12 may include a composite or construction board, blanket, batt, pipe, or roll. The base insulation layer 12 may be constructed from fiberglass, foam, polyiso, or other suitable insulation material. In some embodiments, the base insulation layer 12 includes or is composed of a construction or composite board 18. The construction board 18 is typically a rectangular board having a length L, a width W, and a thickness T, which may be selected based on the application in which the construction board 18 will be used. Common values for the length L include 4-10 feet, whereas common values for the width W include 2-6 feet, and common values for the thickness T include 1-4 inches. The construction board 18 may likewise have a material density or weight of between 1 and 12 lb/ft³, or between 1 and 8 lb/ft³, or between 1.5 and 6 lb/ft³. In some embodiments, the construction board 18 is a fiberglass based board made of an inorganic material (e.g., glass fibers) adhered together with a binder, such as a thermosetting binder or resin. In other embodiments, the construction board 18 may include polymeric fibers. The fiberglass based construction or composite board 18 may be a flexible, semi-rigid, or rigid board that varies in density. One or more opposing sides or surfaces of the construction or composite board 18 may be bonded to or laminated with the non-moisture absorbing facer 14 described herein. For example, a bottom surface or side of second film 16c of non-moisture absorbing facer 14 may be bonded to a top surface or side of the construction board 18. In some embodiments, the non-moisture absorbing facer 14 may match or mirror a size (e.g., length and width) or shape (e.g., rectangular) of the construction board 18. In other embodiments, the non-moisture absorbing facer 14 may have a different size or shape.

The insulation product 10 including the construction board 18 may be used for a variety of insulative applications including insulating residential, industrial, or commercial buildings, structures, or components; insulating oil or gas refineries components and/or structures; insulating chemical plant components and/or structures; insulating an automotive component and/or structure; insulating an aerospace component and/or structure; and the like. Further, in other embodiments, the construction board 18 may not have a rectangular shape, but instead may be configured to be rolled or positioned about a circular object, such as a pipe. In such instances, the construction board 18 may be used to insulate sections of piping that transport hot substances, such as various fluids in oil refineries. In other embodiments, the construction board 18 may not be a board, but rather may be a product that is shaped and configured to insulation various other shapes or even irregular shaped objects. For example, the insulation product 10 may be used as pipe insulation or may be a molded irregular sharp insulation product. Thus, the embodiments described and contemplated here are not limited to any particular geometric shape or design.

With reference to Table 1, compositions of commonly available ASJ facers (e.g., Sample Facer 1, Sample Facer 2) that include one or more moisture absorbing layers (e.g., a kraft paper layer or kraft paper and tissue paper layers, respectively) and of an example non-moisture absorbing facer (e.g., Non-moisture absorbing Facer 1) constructed in accordance with an exemplary embodiment as described herein are provided. As shown in Table 1, Sample Facer 1 and Sample Facer 2 include a kraft paper layer positioned between the reinforcing layer and the white film. Sample Facer 2 includes an additional layer of tissue paper on an underside of the foil layer of the facer. The Non-moisture absorbing Facer 1 was constructed without (e.g., does not include) a kraft paper layer or a tissue paper layer (e.g., no kraft or tissue paper between the reinforcing layer and the white film layer or between the polyester film layer and a construction board). Each of the sample facers (e.g., Sample Facer 1, Sample Facer 2, and Non-moisture absorbing Facer 1) were laminated to boards (e.g., construction boards) to construct sample insulation products or boards (e.g., ceiling tiles) for testing. Testing was then performed on each of the resulting insulation products to evaluate relative wrinkling or welting in the facers as described in more detail below.

TABLE 1
Example Facer Compositions

| Facing | | | | Non-moisture |
|---|---|---|---|---|
| Composition | Description | Sample Facer 1 | Sample Facer 2 | absorbing Facer 1 |
| White Film Layer | Polypropylene | 12.5 lbs/3000 ft² | 12.5 lbs/3000 ft² | 0.0015 inches |
| Adhesive | | Flame resistant | Flame resistant | Flame resistant |
| Paper Layer | Kraft Paper | 30 lbs/3000 ft² | 30 lbs/3000 ft² | N/A |
| Adhesive | | Fire retardant | Flame resistant | N/A |
| Reinforcing | Tri-Directional | 5/inch (MD and | 5/inch (MD and | 4/inch (MD and |
| Layer | Fiberglass | XMD) | XMD) | XMD) |
| Barrier Coating | Polymeric | Polymeric | Polymeric | N/A |
| Layer | | | | |
| Foil/Film Layer | Aluminum or | Aluminum foil | Aluminum foil | Metallized |
| | Metallized | 0.00025 inches | 0.00025 inches | Polyester film |
| | Polyester | | | 0.0005 inches |
| Adhesive | | N/A | Flame resistant | N/A |
| Paper Layer | Tissue Paper | N/A | 11 lbs/3000 ft² | N/A |

### Test 1. Sample Facer 1

Insulation boards were constructed or fabricated with Sample Facer 1. A water based adhesive system was employed to face or laminate construction boards with Sample Facer 1 with two different glue weights (e.g., 3.0 g/ft² and 7.0 g/ft²) to fabricate multiple insulation boards as it was initially thought that if glue application and coverage (e.g., increase in glue weight) were controlled in a more robust manner that such insulation boards (e.g., the facers) would exhibit reduced or no wrinkling when exposed to moisture. The insulation boards faced with Sample Facer 1 were aged for 6 days in a 90 degrees F. and 90% humidified chamber. Wrinkling on the surface of the boards was observed in 100% of the insulation boards laminated with Sample Facer 1 at the lower glue weight (3 g/ft²) within the first 24 hours after the insulation boards were placed in the humidified chamber. Likewise, wrinkling was observed in 100% of the insulation boards laminated with Sample Facer 1 at the higher glue weight (7 g/ft²) within the first 72 hours after the insulation boards were placed in the humidified chamber. While wrinkling developed at a slower rate in the higher glue weight insulation boards, subsequent wrinkling of the boards when exposed to high moisture environments remained unacceptable.

### Test 2. Sample Facer 1 and Sample Facer 2

A second test was developed and performed due to the limits of the amount of glue that can be applied (e.g., glue weight) and the observed wrinkling in insulation boards even when a higher glue weight was used to laminate the construction boards to Sample Facer 1 in Test 1. The water based adhesive system as used in Test 1 was employed to face or laminate construction boards with Sample Facer 1 and Sample Facer 2 to fabricate multiple insulation boards. As discussed above, Sample Facer 2 includes an additional layer of tissue or kraft paper on an underside of the aluminum foil layer of the facer. It was thought that facer with this additional layer may improve tack with water-borne adhesives and the underlying construction board relative to applying the adhesive directly to the aluminum foil surface. With improved tack, it was believed that Sample Facer 2 may stick or adhere better to the construction boards and reduce or prevent wrinkling. Both Sample Facer 1 and Sample Facer 2 were laminated to construction boards with higher glue weights (7 g/ft²) to fabricate the insulation boards for testing. The insulation boards with Sample Facer 1 and Sample Facer 2 were then aged for six days in a 90 degrees F. and 90% humidified chamber. After 6 days, wrinkling was observed in all of the insulation boards with either Sample Facer 1 or Sample Facer 2. In fact, insulation boards with Sample Facer 2 exhibited more severe wrinkling as compared to the other insulation boards of Test 1 and Test 2.

### Test 3. Sample Facer 2 and Non-Moisture Absorbing Facer 1

A third test was then performed by using the water based adhesive system as used in Test 1 to face or laminate construction boards with Sample Facer 2 and Non-moisture absorbing Facer 1 to fabricate multiple insulation boards. As discussed and illustrated above, Non-moisture absorbing Facer 1 consists of or includes an exposed white film layer (e.g., top surface), a tri-directional fiberglass reinforcing layer, a metallized polyester film layer (e.g., bottom surface in contact with top surface of the underlying construction board) and an adhesive bonding the white film layer and metallized polyester film to opposing sides of the tri-directional fiberglass reinforcing layer. Non-moisture absorbing Facer 1 does not include or is constructed without a kraft paper layer as in Sample Facer 1 or a tissue paper layer as in Sample Facer 2. The insulation boards with Sample Facer 2 and Non-moisture absorbing Facer 1 were then aged for four days in a 90 degrees F. and 90% humidified chamber. The Sample Facer 2 and Non-moisture absorbing Facer 1 were laminated to construction boards with lower glue weights (5 g/ft²) than the 7 g/ft² used in Tests 1 and 2 to fabricate the insulation boards. Despite lower weights of adhesive used in Test 3, the insulation boards with Non-moisture absorbing Facer 1 did not exhibit any apparent wrinkling or welting. Significant amounts of wrinkling was observed in Sample Facer 2 insulation boards.

The testing and unexpected results suggest that wrinkling or welting occurs in commonly available facers of insulation boards or products due to the kraft paper or tissue paper layers. For example, severity of wrinkling was reduced as the amount of kraft or paper material was reduced (e.g., when comparing insulation boards with Sample Facer 1 (30 lbs/3000 ft²) to Sample Facer 2 (combined 41 lbs/3000 ft² tissue and kraft layers)). Further, facers constructed without any kraft or paper layers (e.g., Non-moisture absorbing Facer 1) exhibited no apparent wrinkling or welting when exposed to moisture regardless of amount of adhesive used or coverage of the adhesive. It is believed that as a kraft or tissue paper layer of facers absorbs moisture over time, the layer starts to expand either uni-directionally or bi-directionally depending on an orientation of the kraft fibers of the layer. This expansion translates into wrinkles in areas of the facer most susceptible (e.g., areas with relatively lower adhesive levels, or relatively poor adhesive coverage, or relatively poor board flatness that may prevent proper initial tacking). Constructing facers as described herein without the kraft paper or tissue paper layers of commonly available facers provides improved facers for insulation products that may be more resistant to wrinkling or welting when exposed to humidity or other higher moisture environments. Overall costs may also be reduced (e.g., less material, less manufacturing steps) relative to commonly available facers that include such kraft or tissue paper layers.

While several embodiments and arrangements of various components are described herein, it should be understood that the various components and/or combination of components described in the various embodiments may be modified, rearranged, changed, adjusted, and the like. For example, the arrangement of components in any of the described embodiments may be adjusted or rearranged and/or the various described components may be employed in any of the embodiments in which they are not currently described or employed. As such, it should be realized that the various embodiments are not limited to the specific arrangement and/or component structures described herein.

In addition, it is to be understood that any workable combination of the features and elements disclosed herein is also considered to be disclosed. Additionally, any time a feature is not discussed with regard in an embodiment in this disclosure, a person of skill in the art is hereby put on notice that some embodiments of the invention may implicitly and specifically exclude such features, thereby providing support for negative claim limitations.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth. The term “or” in reference to a list of two or more items, covers all of the following interpretations of the word: any of the items in the list, all of the items in the list, and any combination of items in the list.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

1. A non-moisture absorbing facer for an insulation product, the non-moisture absorbing facer comprising: one or more layers configured to be coupled to an insulation layer to form an insulation product, the one or more layers including a reinforcing layer and the one or more layers excluding a moisture absorbing layer between the one or more layers.

2. The non-moisture absorbing facer of claim 1, wherein the one or more layers include a first film layer and a second film layer, the first and second film layers sandwiching the reinforcing layer therebetween.

3. The non-moisture absorbing facer of claim 2, wherein the first film layer and the second film layer comprise a polymeric film.

4. The non-moisture absorbing facer of claim 3, wherein the first film layer comprises a polypropylene or coated polyester film.

5. The non-moisture absorbing facer of claim 4, wherein the polypropylene film comprises a substantially white-colored film.

6. The non-moisture absorbing facer of claim 3, wherein the second film layer comprises a metallized polyester film or metallized foil.

7. The non-moisture absorbing facer of claim 1, wherein the reinforcing layer comprises a fiberglass mat.

8. The non-moisture absorbing facer of claim 7, wherein the fiberglass mat comprises a tri-directional fiberglass scrim.

9. The non-moisture absorbing facer of claim 1, wherein the one or more layers are laminated together.

10. The non-moisture absorbing facer of claim 1, wherein the one or more layers consist of a first film layer and a second film layer sandwiching the reinforcing layer therebetween, the layers being bonded together with an adhesive.

11. The non-moisture absorbing facer of claim 1, further comprising an insulation layer coupled to the non-moisture absorbing facer.

12. The non-moisture absorbing facer of claim 11, wherein the insulation layer comprises a fiberglass based construction board.

13. The non-moisture absorbing facer of claim 2, wherein the first film layer is bonded directly to the reinforcing layer with an adhesive without any intermediary layers.

14. The non-moisture absorbing facer of claim 2, wherein a bottom surface of the second film layer is laminated directly to a top surface of the insulation layer with an adhesive without any intermediary layers.

15. The non-moisture absorbing facer of claim 1, wherein the moisture absorbing layer that is excluded is a kraft paper layer.

16. An insulation product comprising:
a base insulation layer; and
a non-moisture absorbing facer bonded to the base insulation layer, wherein the non-moisture absorbing facer comprises one or more layers, the one or more layers including a reinforcing layer and the one or more layers excluding a kraft paper layer between the one or more layers.

17. The insulation product of claim 16, wherein the one or more layers include a first film layer and a second film layer, the first and second film layers sandwiching the reinforcing layer therebetween.

18. The insulation product of claim 16, wherein the base insulation layer comprises a fiberglass based construction board.

19. The insulation product of claim 17, wherein the non-moisture absorbing facer is pre-fabricated without the kraft paper layer prior to being bonded to the base insulation layer.

20. The insulation product of claim 16, wherein the non-moisture absorbing facer has a thickness in a range between 0.005 and 0.009 inches.

21. The insulation product of claim 16, wherein the insulation product is a ceiling tile.

22. A method of manufacturing a non-moisture absorbing facer for an insulation product, the method comprising:
bonding a first film layer directly to a first side of a fiberglass reinforcing layer without a first moisture absorbing intermediary layer therebetween;
bonding a second film layer directly to a second opposing side of the fiberglass reinforcing layer without a second moisture absorbing intermediary layer therebetween.

23. The method of manufacturing a non-moisture absorbing facer of claim 22, wherein the first film layer comprises a polypropylene layer.

24. The method of manufacturing a non-moisture absorbing facer of claim 22, wherein the second film layer comprises a metallized polyester layer.

25. The method of manufacturing a non-moisture absorbing facer of claim 22, wherein the fiberglass reinforcing layer comprises a tri-directional fiberglass scrim.

26. The method of manufacturing a non-moisture absorbing facer of claim 22, further comprising laminating the non-moisture absorbing facer to a construction board.

27. The method of manufacturing a non-moisture absorbing facer of claim 26, wherein the non-moisture absorbing facer is laminated with between 3 g/ft² and 7 g/ft² weight adhesive to the construction board.

28. The method of manufacturing a non-moisture absorbing facer of claim 26, wherein the second film layer is laminated directly to a surface of the construction board without an intermediary layer.

29. The method of manufacturing a non-moisture absorbing facer of claim 22, wherein the non-moisture absorbing facer and construction board form a ceiling tile.

30. The method of manufacturing a non-moisture absorbing facer of claim 22, wherein the non-moisture absorbing facer has a thickness in a range between 0.005 and 0.009 inches.

31. An insulation product consisting essentially of:
a base insulation layer; and
a non-moisture absorbing facer bonded to the base insulation layer, wherein the non-moisture absorbing facer does not include a moisture absorbing layer.

32. The insulation product of claim 31, wherein the non-moisture absorbing facer does not include a kraft paper layer.

33. The insulation product of claim 31, wherein the base insulation layer is a fiberglass based construction board.

34. The non-moisture absorbing facer of claim 1, wherein the insulation product is configured to be positioned about a circular object.

35. The insulation product of claim 16, wherein the base insulation layer and the non-moisture absorbing facer are configured to be positioned about a circular object.

36. The method of manufacturing a non-moisture absorbing facer of claim 22, further comprising positioning the a first film layer, the fiberglass reinforcing layer, and the second film layer about a circular object.

37. The insulation product of claim 31, wherein the base insulation layer and the non-moisture absorbing facer are configured to be positioned about a circular object.
